(19) United States
(12) Patent Application Publication
(10) Pub. No.: US 2023/0262418 A1
(43) Pub. Date: Aug. 17, 2023

(54) METHOD AND APPARATUS FOR LOCATION SERVICE

(71) Applicant: Telefonaktiebolaget LM Ericsson (publ), Stockholm (SE)

(72) Inventor: Wenliang Xu, Shanghai (CN)

(21) Appl. No.: 18/015,119

(22) PCT Filed: Jul. 8, 2021
(86) PCT No.: PCT/CN2021/105276

§ 371 Date: Jan. 9, 2023

(30) Foreign Application Priority Data
Jul. 10, 2020 (WO) PCT/CN2020/101356

(51) Int. Cl. H04W 4/029; H04W 8/08

(52) U.S. Cl. CPC H04W 4/029; H04W 8/08

(57) ABSTRACT

Embodiments of the present disclosure provide methods and apparatuses for location service. A method at a location management server comprises receiving a location reporting trigger for activating a location reporting procedure for obtaining location information of a first location management client from a client or a server. The location reporting trigger comprises endpoint information of the client or the server. The method further comprises initiating a location reporting procedure for the location information of the first location management client. The method further comprises sending a location information report comprising the location information of the first location management client to the client or the server based on the endpoint information of the client or the server when location information of the first location management client is available in the location management server.

### TECHNICAL FIELD

The non-limiting and exemplary embodiments of the present disclosure generally relate to the technical field of communications, and specifically to methods and apparatuses for location service.

### BACKGROUND

This section introduces aspects that may facilitate a better understanding of the disclosure. Accordingly, the statements of this section are to be read in this light and are not to be understood as admissions about what is in the prior art or what is not in the prior art.

3rd Generation Partnership Project (3GPP) TS 23.434 V16.4.0, the disclosure of which is incorporated by reference herein in its entirety, has specified an architecture that can allow pieces of functionality (services) to be used across different verticals. Service Enabler Architecture Layer (SEAL) provides services to support vertical applications over the 3GPP system. SEAL is applicable to vertical applications using Evolved Universal Terrestrial Radio Access Network (E-UTRAN) or NR (new radio) access based on the Evolved Packet Core (EPC) or fifth generation system (5GS) architecture as defined in 3GPP TS 23.401 V16.6.0 and 3GPP TS 23.501 V16.4.0, the disclosures of which are incorporated by reference herein in its entirety. The SEAL services may ensure efficient use and deployment of vertical applications over the 3GPP system. The SEAL services may include the group management, configuration management, location management, identity management, key management and network resource management.

SEAL services are supported for both on-network and off-network functional model. FIG. 1 illustrates a generic on-network functional model for SEAL, which is same as FIGS. 6.2-1 of 3GPP TS 23.434 V16.4.0. In the vertical application layer, the Vertical Application Layer (VAL) client communicates with the VAL server over VAL-UU reference point which is an instance of Uu reference point as described in 3GPP TS 23.401 V16.6.0 and 3GPP TS 23.501 V16.4.0. VAL-UU supports both unicast and multicast delivery modes. The SEAL functional entities on the user equipment (UE) and the server are grouped into SEAL client(s) and SEAL server(s) respectively. The SEAL may include a common set of services (e.g. group management, location management) and reference points. The SEAL offers its services to the vertical application layer (VAL).

The vertical application layer may further include vertical application enabler layer functionalities (specified by 3GPP) and application specific functionalities. The SEAL client(s) communicates with the SEAL server(s) over the SEAL-UU reference points. SEAL-UU supports both unicast and multicast delivery modes. The SEAL client(s) provides the service enabler layer support functions to the VAL client(s) over SEAL-C reference points. The VAL server(s) communicate with the SEAL server(s) over the SEAL-S reference points. The SEAL server(s) may communicate with the underlying 3GPP network systems using the respective 3GPP interfaces specified by the 3GPP network system.

FIG. 2 illustrates a generic on-network functional model for location management, which is similar to FIG. 9.2.2-1 of 3GPP TS 23.434 V16.4.0. The location management client (LMC) communicates with the location management server (LMS) over the LM-UU reference point. The location management client provides the support for location management functions to the VAL client(s) over LM-C reference point. The VAL server(s) communicates with the location management server over the LM-S reference point. The location management server communicates with the service capability exposure function (SCEF) via T8 reference point or the Network Exposure Function (NEF) via N33 reference point to obtain location information from the underlying 3GPP network system.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There are some problems for the existing location management. FIG. 3 illustrates a high level procedure of client-triggered or VAL server-triggered location reporting, which is same as the FIG. 9.3.5-1 of 3GPP TS 23.434 V16.4.0. At step 1, location management client 2 (authorized VAL user or VAL UE) or VAL server sends a location reporting trigger to the location management server to activate a location reporting procedure for obtaining the location information of location management client 1. At step 2, Location management server checks whether location management client 2 or VAL server is authorized to send a location reporting trigger. Depending on the information specified by the location reporting trigger, location management server initiates an on-demand location reporting procedure or an event-triggered location reporting procedure for the location of location management client 1.

Table 1 describes the information flow from the location management client to the location management server for triggering a location reporting procedure. Table 1 is same as Table 9.3.2.4-1 of 3GPP TS 23.434 V16.4.0.

TABLE 1

| Information element | Status | Description |
|---|---|---|
| Identity | M (NOTE 1) | Identity of the requesting authorized VAL user or |
| | | VAL UE |
| Identity | M (NOTE 1) | Identity of the requested VAL user or VAL UE |
| Immediate Report Indicator | O (NOTE 2) | Indicates whether an immediate location report is |
| | | required |
| Requested location information | O (NOTE 2) | Identifies what location information is requested |
| Triggering criteria | O (NOTE 2) | Identifies when the client will send the location |
| | | report |
| Minimum time between | O (NOTE 2) | Defaults to 0 if absent otherwise indicates the |
| consecutive reports | | interval time between consecutive reports |

(NOTE 1):
The identity of the requesting VAL user/UE and the requested VAL user/UE should belong to the same VAL service.
(NOTE 2):
At least one of these rows shall be present.

FIG. 4 illustrates an on-demand location information reporting procedure, which is same as FIG. 9.3.4-1 of 3GPP TS 23.434 V16.4.0. The location management server can request UE location information at any time by sending a location information request to the location management client, which may trigger location management client to immediately send the location report.

The problem for immediate reporting is the location information is not sent to the LMC or VAL server which has explicitly asked LMS.

For the “requested location information”, “triggering criteria” and “minimum time between consecutive reports”, they are related to the Event-triggered location reporting procedure as described in clause 9.3.3.2 of 3GPP TS 23.434 V16.4.0.

FIG. 5a illustrates a procedure for fetching location reporting configuration, which is same as FIG. 9.3.3.2-1 of 3GPP TS 23.434 V16.4.0.

Table 2 describes a information flow from the location management server to the location management client for the location reporting configuration, which is same as Table 9.3.2.1-1 of 3GPP TS 23.434 V16.4.0. This information flow may be sent individually addressed or group addressed on unicast or multicast.

TABLE 2

| Information element | Status | Description |
|---|---|---|
| Identity | M | Identity of the VAL user or VAL group to which the |
| | | location reporting configuration is targeted or |
| | | identity of the VAL UE. |
| Requested location information | O (NOTE) | Identifies what location information is requested |
| Triggering criteria | O (NOTE) | Identifies when the location management client will |
| | | send the location report |
| Minimum time between | O (NOTE) | Defaults to 0 if absent otherwise indicates the time |
| consecutive reports | | interval between consecutive reports |

(NOTE):
If none of the information element is present, this represents a cancellation for location reporting.

FIG. 5b illustrates a procedure for location reporting, which is same as FIG. 9.3.3.3-1 of 3GPP TS 23.434 V16.4.0. The LMC reports the location information based on previously received location reporting event triggers.

To maintain multiple location reporting trigger configurations in order to satisfy different VAL server/LMC need (e.g. VAL server A requires Service Area Identifier (SAI) change, VAL server B requires E-UTRAN Cell Global Identifier (ECGI) change with minimum time 10 minutes between consecutive reports), the current information sent from LMS to the target LMC is not enough to identify different requests because there is only one active configuration sent to the target LMC.

The existing location management solution is incapable to fulfill immediate reporting requirement for requesting VAL UE/user. The existing location management solution cannot support multiple location reporting trigger configurations.

In the existing location management solution, the immediate reporting requirement in client-triggered or VAL server-triggered location reporting is missing the corresponding immediate location report.

In the existing location management solution, the existing procedures and information flows for supporting co-existence of multiple location reporting trigger configurations on the LMS and target LMC are also missing.

To overcome or mitigate at least one above mentioned problems or other problems, the embodiments of the present disclosure propose an improved location service.

In a first aspect of the disclosure, there is provided a method at a location management server. The method comprises receiving a location reporting trigger for activating a location reporting procedure for obtaining location information of a first location management client from a client or a server. The location reporting trigger comprises endpoint information of the client or the server. The method further comprises initiating a location reporting procedure for the location information of the first location management client. The method further comprises, when location information of the first location management client is available in the location management server, sending a location information report comprising the location information of the first location management client to the client or the server based on the endpoint information of the client or the server.

In an embodiment, the method further comprises receiving a location reporting configuration request from the first location management client. The method further comprises ending a location reporting configuration response to the first location management client. The location reporting configuration response comprises at least one location reporting trigger configuration identified by a corresponding configuration identity.

In an embodiment, each of the at least one location reporting trigger configuration comprises at least one of requested location information, triggering criteria, and a minimum time between consecutive reports.

In an embodiment, the location reporting configuration response further comprises an identity of a vertical application layer (VAL) user or an identity of a VAL group to which the location reporting configuration is targeted or an identity of the VAL user equipment.

In an embodiment, the method further comprises sending a location reporting configuration cancel request to the first location management client. In an embodiment, the method further comprises receiving a location reporting configuration cancel response from the first location management client. The location reporting configuration cancel request comprises at least one configuration identity for invalidating at least one location reporting event trigger configuration identified by the at least one configuration identity, or wherein when the location reporting configuration cancel request does not comprise any configuration identity, all the location reporting event trigger configurations are invalidated.

In an embodiment, the method further comprises sending a location reporting configuration update request to the first location management client. In an embodiment, the method further comprises receiving a location reporting configuration update response from the first location management client. The location reporting configuration update request comprises update information regarding at least one location reporting trigger configuration identified by a corresponding configuration identity.

In an embodiment, the method further comprises receiving a location information report from the first location management client. The location information report includes location information and one or more configuration identities. In an embodiment, the method further comprises updating the location information related to the one or more configuration identities based on the received location information.

In an embodiment, the location reporting procedure comprises sending a location information request to the first location management client. The location reporting procedure further comprises receiving a location information report from the first location management client. The location reporting procedure further comprises updating the location information of the first location management client based on the location information report.

In an embodiment, when the location reporting trigger comprises an indicator for indicating that an immediate location report is required, the location information of the first location management client is sent to the client or the server immediately.

In an embodiment, the client is a second location management client and the server is a vertical application layer (VAL) server.

In an embodiment, a communication between a location management client and the location management server is implemented through a third Generation Partnership Project (3GPP) network system.

In an embodiment, the location management server is a Service Enabler Architecture Layer for Verticals (SEAL) server and the location management client is a vertical application layer (VAL) client.

In a second aspect of the disclosure, there is provided a method at a client or a server. The method comprises sending a location reporting trigger for activating a location reporting procedure for obtaining location information of a first location management client to a location management server. The location reporting trigger comprises endpoint information of the client or the server. The method further comprises receiving a location information report comprising the location information of the first location management client from the location management server.

In an embodiment, when the client is a location management client, the method further comprises sending a location reporting configuration request to the location management server. The method further comprises receiving a location reporting configuration response from the location management server. The location reporting configuration response comprises at least one location reporting trigger configuration identified by a corresponding configuration identity.

In an embodiment, each of the at least one location reporting trigger configuration comprises at least one of requested location information, triggering criteria, and a minimum time between consecutive reports.

In an embodiment, the location reporting configuration response further comprises an identity of a vertical application layer (VAL) user or an identity of a VAL group to which the location reporting configuration is targeted or an identity of the VAL user equipment.

In an embodiment, the method further comprises receiving a location reporting configuration cancel request from the location management server. In an embodiment, the method further comprises, when the location reporting configuration cancel request comprises at least one configuration identity, invalidating at least one location reporting event trigger configuration identified by the at least one configuration identity. In an embodiment, the method further comprises, when the location reporting configuration cancel request does not comprise any configuration identity, invalidating all the location reporting event trigger configurations. In an embodiment, the method further comprises sending a location reporting configuration cancel response to the location management server.

In an embodiment, the method further comprises receiving a location reporting configuration update request from the location management server. The location reporting configuration update request comprises update information regarding at least one location reporting trigger configuration identified by a corresponding configuration identity. In an embodiment, the method further comprises updating the at least one location reporting trigger configuration identified by a corresponding configuration identity based on the update information. In an embodiment, the method further comprises sending a location reporting configuration update response to the location management server.

In an embodiment, the method further comprises sending a location information report to the location management server. The location information report includes location information and one or more configuration identities.

In an embodiment, a communication between the first location management client and the location management server is implemented through a third Generation Partnership Project (3GPP) network system.

In an embodiment, the location management server is a Service Enabler Architecture Layer for Verticals (SEAL) server and the first location management client is a vertical application layer (VAL) client.

In an embodiment, when the location reporting trigger comprises an indicator for indicating that an immediate location report is required, the location information of the first location management client is sent to the client or the server immediately.

In a third aspect of the disclosure, there is provided a location management server. The location management server comprises a processor and a memory coupled to the processor. Said memory contains instructions executable by said processor. Said location management server is operative to receive a location reporting trigger for activating a location reporting procedure for obtaining location information of a first location management client from a client or a server. The location reporting trigger comprises endpoint information of the client or the server. Said location management server is further operative to initiate a location reporting procedure for the location information of the first location management client. Said location management server is further operative to, when location information of the first location management client is available in the location management server, send a location information report comprising the location information of the first location management client to the client or the server based on the endpoint information of the client or the server.

In a fourth aspect of the disclosure, there is provided a client or a server. The client or server comprises a processor and a memory coupled to the processor. Said memory contains instructions executable by said processor. Said client or server is operative to send a location reporting trigger for activating a location reporting procedure for obtaining location information of a first location management client to a location management server. The location reporting trigger comprises endpoint information of the client or the server. Said client or server is further operative to receive a location information report comprising the location information of the first location management client from the location management server.

In a fifth aspect of the disclosure, there is provided a location management server. The location management server comprises a receiving module, an initiating module and a sending module. The receiving module may be configured to receive a location reporting trigger for activating a location reporting procedure for obtaining location information of a first location management client from a client or a server. The location reporting trigger comprises endpoint information of the client or the server. The initiating module may be configured to initiate a location reporting procedure for the location information of the first location management client. The sending module may be configured to, when location information of the first location management client is available in the location management server, send a location information report comprising the location information of the first location management client to the client or the server based on the endpoint information of the client or the server.

In a sixth aspect of the disclosure, there is provided a client or a server. The client or server comprises a sending module and a receiving module. The sending module may be configured to send a location reporting trigger for activating a location reporting procedure for obtaining location information of a first location management client to a location management server. The location reporting trigger comprises endpoint information of the client or the server. The receiving module may be configured to receive a location information report comprising the location information of the first location management client from the location management server.

In another aspect of the disclosure, there is provided a computer program product, comprising instructions which, when executed on at least one processor, cause the at least one processor to carry out any of the method according to the first and second aspects of the disclosure.

In another aspect of the disclosure, there is provided a computer-readable storage medium storing instructions which, when executed by at least one processor, cause the at least one processor to carry out any of the method according to the first and second aspects of the disclosure.

Embodiments herein afford many advantages, of which a non-exhaustive list of examples follows. In some embodiments herein, the proposed solution may fulfill immediate reporting requirement for requesting VAL UE/user in the existing location management procedure for SEAL on-network model. In some embodiments herein, the proposed solution may support multiple location reporting trigger configurations in the existing location management procedure for SEAL on-network model. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates a generic on-network functional model for SEAL;

FIG. 2 illustrates a generic on-network functional model for location management;

FIG. 3 illustrates a high level procedure of client-triggered or VAL server-triggered location reporting;

FIG. 4 illustrates an on-demand location information reporting procedure;

FIG. 5a illustrates a procedure for fetching location reporting configuration;

FIG. 5b illustrates a procedure for location reporting;

FIG. 6a schematically shows a high level architecture in a 4G network;

FIG. 6b schematically shows a high level architecture in a 5G network;

FIG. 7 shows a flowchart of a method according to an embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of a method according to another embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of a method according to another embodiment of the present disclosure;

FIG. 14 shows a flowchart of a method according to another embodiment of the present disclosure;

FIG. 15 shows a flowchart of a method according to another embodiment of the present disclosure;

FIG. 16 shows a flowchart of event-triggered location reporting according to another embodiment of the present disclosure;

FIG. 17 shows a flowchart of location reporting event triggers configuration cancel according to another embodiment of the present disclosure;

FIG. 18 shows a flowchart of location reporting procedure according to another embodiment of the present disclosure;

FIG. 19a shows a flowchart of on-demand location information reporting procedure according to another embodiment of the present disclosure;

FIG. 19b illustrates the high level procedure of client-triggered or VAL server-triggered location reporting according to another embodiment of the present disclosure;

FIG. 20 is a block diagram showing an apparatus suitable for practicing some embodiments of the disclosure;

FIG. 21 is a block diagram showing a location management server according to an embodiment of the disclosure; and

FIG. 22 is a block diagram showing a client or a server according to an embodiment of the disclosure.

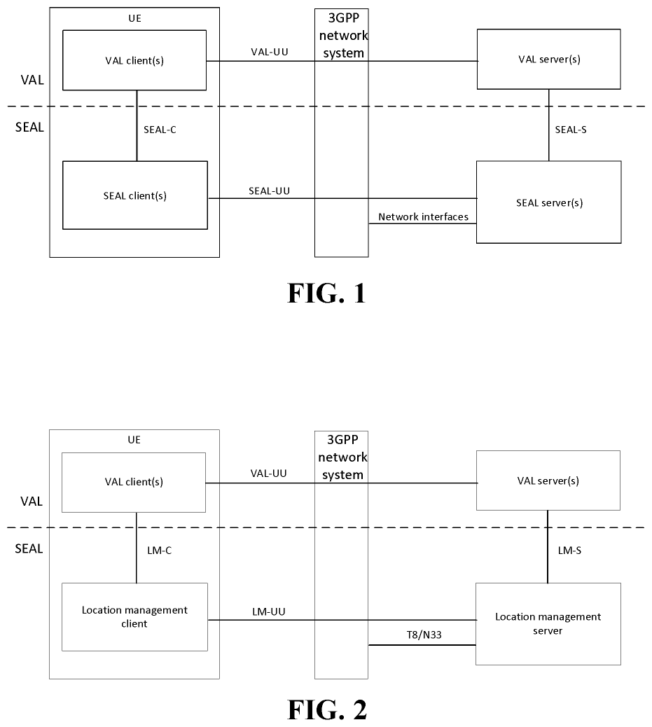

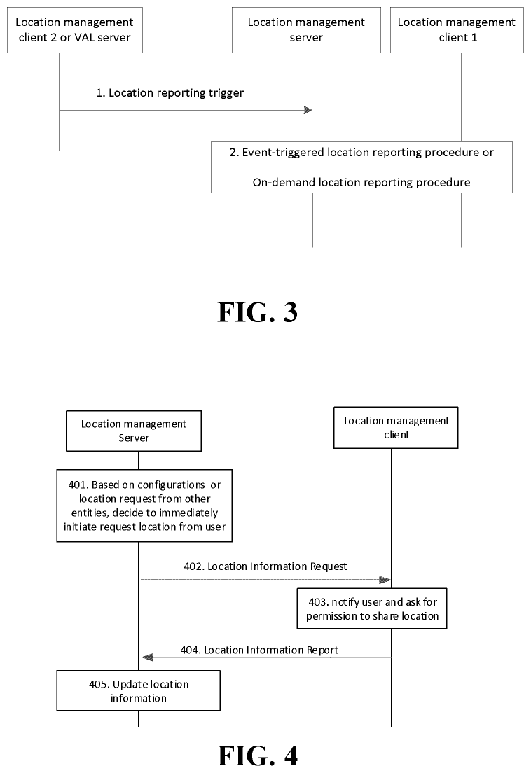

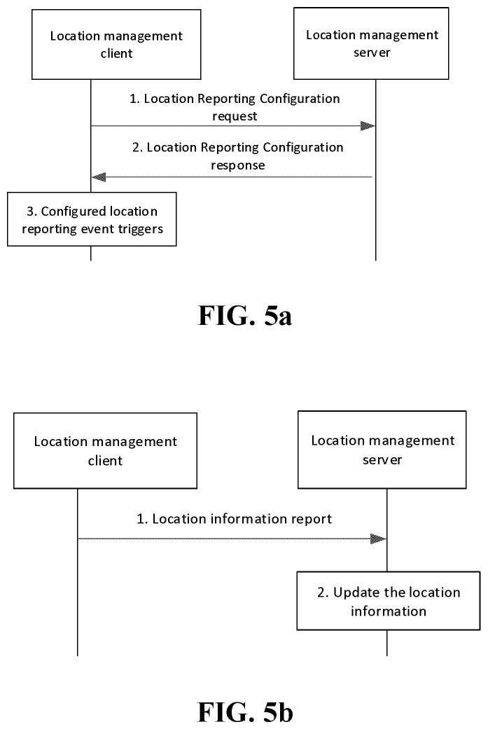

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable (wireless or wired) communication standards. For example, the wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols. For example, the wireless communication protocols may comprise the first generation (1G), 2G, 3G, 4G, 4.5G, 5G communication protocols, and/or any other protocols either currently known or to be developed in the future.

The term “entity” used herein refers to a network device or network node or network function in a communication network. For example, in a wireless communication network such as a 3GPP-type cellular network, a core network device may offer numerous services to customers who are interconnected by an access network device. Each access network device is connectable to the core network device over a wired or wireless connection.

The term “network function” refers to any suitable function which can be implemented in a network entity (physical or virtual) of a communication network. For example, a network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), etc. For example, the 4G system (such as LTE) may include MME (Mobile Management Entity), HSS (home subscriber server), SCEF, etc. In other embodiments, the network function may comprise different types of NFs for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to the cellular network as defined by 3GPP being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies such as wireless sensor network may equally be utilized as long as exemplary embodiments described herein are applicable.

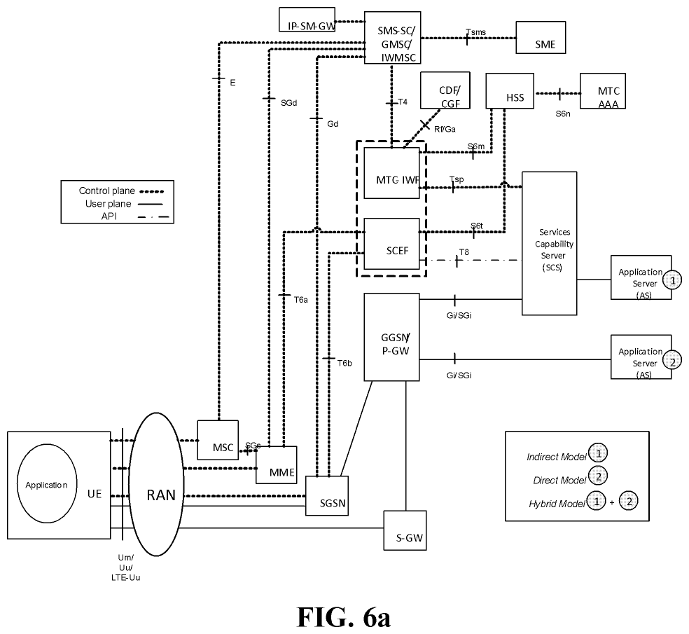

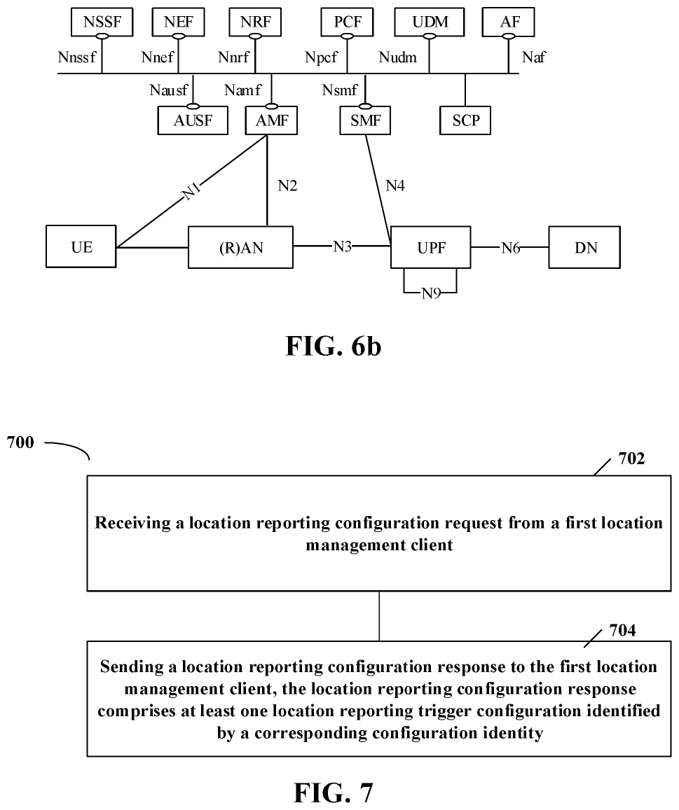

FIGS. 6a and 6b show some system architectures in which the embodiments of the present disclosure can be implemented. For simplicity, the system architectures of FIGS. 6a and 6b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 6a schematically shows a high level architecture in a 4G network, which is same as FIG. 4.2-1a of 3GPP TS 23.682 V16.6.0, the disclosure of which is incorporated by reference herein in its entirety. The system architecture of FIG. 6a may comprise some exemplary elements such as SCS (services capability server), AS (application server), SCEF, HSS (home subscriber server), UE, RAN(Radio Access Network), SGSN (Serving GPRS (General Packet Radio Service) Support Node), MME (Mobile Management Entity), MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC(Short Message Service-Service Centre/Gateway MSC/InterWorking MSC) IP-SM-GW (Internet protocol Short Message Gateway). The network elements and interfaces as shown in FIG. 6a may be same as the corresponding network elements and interfaces as described in 3GPP TS 23.682 V16.6.0.

FIG. 6b schematically shows a high level architecture in a 5G network, which is same as FIG. 4.2.3-1 of 3GPP TS 23.501 V16.4.0, the disclosure of which is incorporated by reference herein in its entirety. The system architecture of FIG. 6b may comprise some exemplary elements such as AMF, SMF, AUSF, UDM, PCF, AF, NEF, UPF and NRF, (R)AN, SCP, etc. The network elements, reference points and interfaces as shown in FIG. 6b may be same as the corresponding network elements, reference points and interfaces as described in 3GPP TS 23.501 V16.4.0.

The exposure function entity such as SCEF and NEF may provide a means to securely expose the services and capabilities provided by the network (such as 3GPP network) interfaces. The exposure function entity may provide a means for the discovery of the exposed services and capabilities. The exposure function entity may provide access to network capabilities through network application programming interfaces (e.g. Network APIs (Application Programming Interfaces)). The exposure function entity may abstract the services from the underlying network interfaces and protocols.

There may be various kinds of network exposure services. For example, monitoring capability may used be for monitoring of specific event for a terminal device in a network such as 4G/5G system and making such monitoring events information available for external exposure via the exposure function entity such as SCEF/NEF. The provisioning capability may used be for allowing external party to provision of information which can be used for the terminal device such as UE in the network such as 4G/5G system. The policy/charging capability may used be for handling QoS (quality of service) and charging policy for the terminal device such as UE based on the request from an external party. The analytics reporting capability may used be for allowing an external party to fetch or subscribe/unsubscribe to analytics information generated by the network such as 4G/5G system. Data capability may used be for allowing an external party to communicate with a terminal device such as UE via an application programming interface.

In an embodiment, the exposure function entity may support network exposure function and network exposure services as described in 3GPP TS 23.501 V16.4.0.

In an embodiment, the exposure function entity may support the network exposure function as described in 3GPP TS 23.682 V16.6.0.

FIG. 7 shows a flowchart of a method 700 according to an embodiment of the present disclosure, which may be performed by an apparatus implemented in or at or as a location management server or communicatively coupled to the location management server. As such, the apparatus may provide means or modules for accomplishing various parts of the method 700 as well as means or modules for accomplishing other processes in conjunction with other components.

The location management server may be a functional entity that receives and stores user location information and provides user location information to any other device such as the vertical application server. The location management server may also acquire location information provided by Public Land Mobile Network (PLMN) operator for example via T8 reference point or N33 reference point. The location management server acts as Common API Framework (CAPIF)'s API exposing function as specified in 3GPP TS 23.222 V17.1.0, the disclosures of which are incorporated by reference herein in its entirety. The location management server also supports interactions with the corresponding location management server in distributed SEAL deployments.

At block 702, the location management server receives a location reporting configuration request from a first location management client. The location management client functional entity may act as the application client for location management functions. The location management client interacts with the location management server. The location management client also supports interactions with the corresponding location management client between the two UEs. The location management client is aware that the location reporting configuration is available at the location management server. The location management client may send a location reporting configuration request message to the location management server.

The location reporting configuration request may include any suitable information such as identity of the VAL user or identity of the VAL UE. In an embodiment, the location reporting configuration request may be same as the location reporting configuration request as described in clause 9.3.2.0 of 3GPP TS 23.434 V16.4.0.

At block 704, the location management server sends a location reporting configuration response to the first location management client. The location reporting configuration response may comprise at least one location reporting trigger configuration identified by a corresponding configuration identity. The location reporting configuration response may further comprise any other suitable information.

Since different devices such as requesting LMC or VAL server may configure different location reporting criteria on the location management server, when the target LMC fetches the location reporting configuration from the location management server, the location reporting configuration response may include multiple trigger configurations. The target LMC may store those configurations and prepare respective location report.

In an embodiment, the location reporting configuration response may further comprise requested location information; triggering criteria; and a minimum time between consecutive reports. The requested location information may identify what location information is requested. The triggering criteria may identify when the location management client will send the location report. The minimum time between consecutive reports may indicate the time interval between consecutive reports. The minimum time between consecutive reports may be 0 by default if the minimum time between consecutive reports is absent.

In an embodiment, the location reporting configuration response may further comprise an identity of a vertical application layer (VAL) user or an identity of a VAL group to which the location reporting configuration is targeted or an identity of the VAL user equipment.

In an embodiment, the location reporting configuration response may be sent individually addressed or group addressed on unicast or multicast. Table 3 shows an example of the location reporting configuration response.

TABLE 3

| Information element | Status | Description |
|---|---|---|
| Identity | M | Identity of the VAL user or VAL group to which the |
| | | location reporting configuration is targeted or |
| | | identity of the VAL UE. |
| location reporting trigger | O (NOTE) | The location reporting trigger configuration list |
| configuration(s) | | |
| >Configuration ID | O (NOTE) | Identifies a specific configuration, shall be provided |
| | | when more than one configuration is supplied. |
| >Requested location information | O (NOTE) | Identifies what location information is requested |
| >Triggering criteria | O (NOTE) | Identifies when the location management client will |
| | | send the location report |
| >Minimum time between | O (NOTE) | Defaults to 0 if absent otherwise indicates the time |
| consecutive reports | | interval between consecutive reports |

(NOTE):
If none of the information element is present, this represents a cancellation for location reporting.

The location management server may send a location reporting configuration message to the location management client(s), containing the at least one location reporting trigger configuration (or a subsequent update) identified by a corresponding configuration identity, e.g. minimum time between consecutive reports, SAI changes, or ECGI changes for reporting the location of the VAL UE. This message can be sent over a unicast bearer to a specific location management client or as a group message over a Multimedia Broadcast and Multicast Service (MBMS) bearer to update the location reporting configuration for multiple location management clients at the same time. The location reporting configuration information can be made part of the user profile, in which case the sending of the message is not necessary. Different location management clients may be given different location reporting criteria. The location management client may store or update the location reporting event triggers configuration. When a location reporting event occurs, the location management client may trigger location information report.

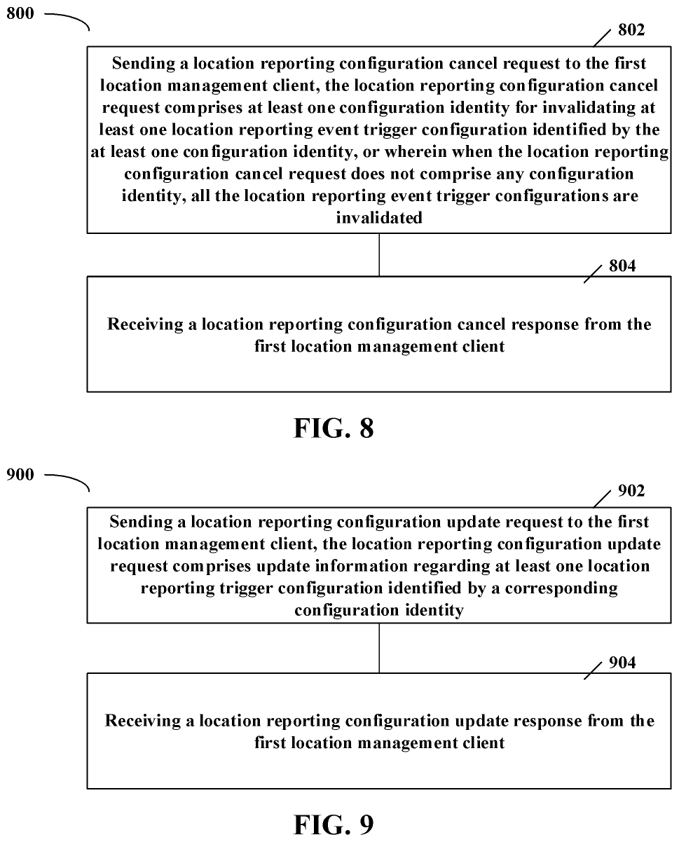

FIG. 8 shows a flowchart of a method 800 according to another embodiment of the present disclosure, which may be performed by an apparatus implemented in or at or as a location management server or communicatively coupled to the location management server. As such, the apparatus may provide means or modules for accomplishing various parts of the method 800 as well as means or modules for accomplishing other processes in conjunction with other components.

At block 802, the location management server sends a location reporting configuration cancel request to the first location management client. The location reporting configuration cancel request comprises at least one configuration identity for invalidating at least one location reporting event trigger configuration identified by the at least one configuration identity. When the location reporting configuration cancel request does not comprise any configuration identity, all the location reporting event trigger configurations are invalidated.

The location management server may send the location reporting configuration cancel request to the location management client to stop receiving the location information. This location reporting configuration cancel request can be sent via unicast or multicast.

For location reporting configuration cancellation, the location management client invalidates the location reporting event triggers configuration for the indicated configuration identity (ID). If no configuration ID is provided, the location management client invalidates all location reporting event triggers configuration(s) and no longer reports its location to the location management server.

At block 804, the location management server receives a location reporting configuration cancel response from the first location management client.

FIG. 9 shows a flowchart of a method 900 according to another embodiment of the present disclosure, which may be performed by an apparatus implemented in or at or as a location management server or communicatively coupled to the location management server. As such, the apparatus may provide means or modules for accomplishing various parts of the method 900 as well as means or modules for accomplishing other processes in conjunction with other components.

At block 902, the location management server sends a location reporting configuration update request to the first location management client. The location reporting configuration update request comprises update information regarding at least one location reporting trigger configuration identified by a corresponding configuration identity. The update operation may include at least one of deleting, adding or modifying operation.

At block 904, the location management server receives a location reporting configuration update response from the first location management client.

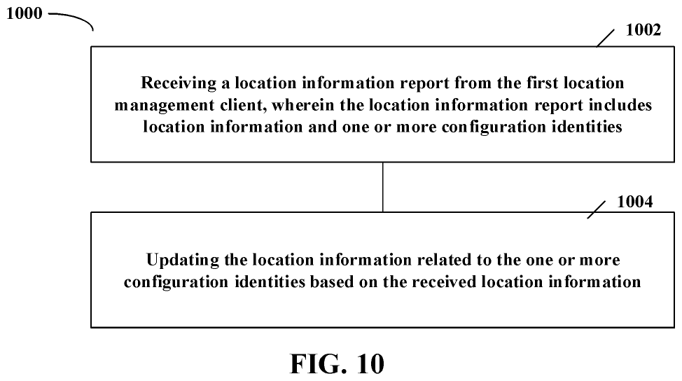

FIG. 10 shows a flowchart of a method 1000 according to an embodiment of the present disclosure, which may be performed by an apparatus implemented in or at or as a location management server or communicatively coupled to the location management server. As such, the apparatus may provide means or modules for accomplishing various parts of the method 1000 as well as means or modules for accomplishing other processes in conjunction with other components.

At block 1002, the location management server receives a location information report from the first location management client. The location information report includes location information and one or more configuration identities. The location management client may send a location information report to the location management server, containing location information identified by the one or more configuration identities and available to the location management client. Table 4 shows an example of the location information report.

TABLE 4

| Information element | Status | Description |
|---|---|---|
| Set of identities | M | Set of identities of the |
| | | reporting VAL users or VAL |
| | | UEs |
| Triggering event | M | Identity of the event that |
| | | triggered the sending of |
| | | the report |
| Location Information | M | Location information |
| Configuration ID | O | Identifies a specific configuration, |
| | | shall be provided when more than |
| | | one configuration was received |
| | | from the location management server. |

At block 1004, the location management server updates the location information related to the one or more configuration identities based on the received location information. Upon receiving the location information report, the location management server updates location of the reporting location management client. If the location management server does not have location information of the reporting location management client before, then the location management server just stores the reporting location information for that location management client.

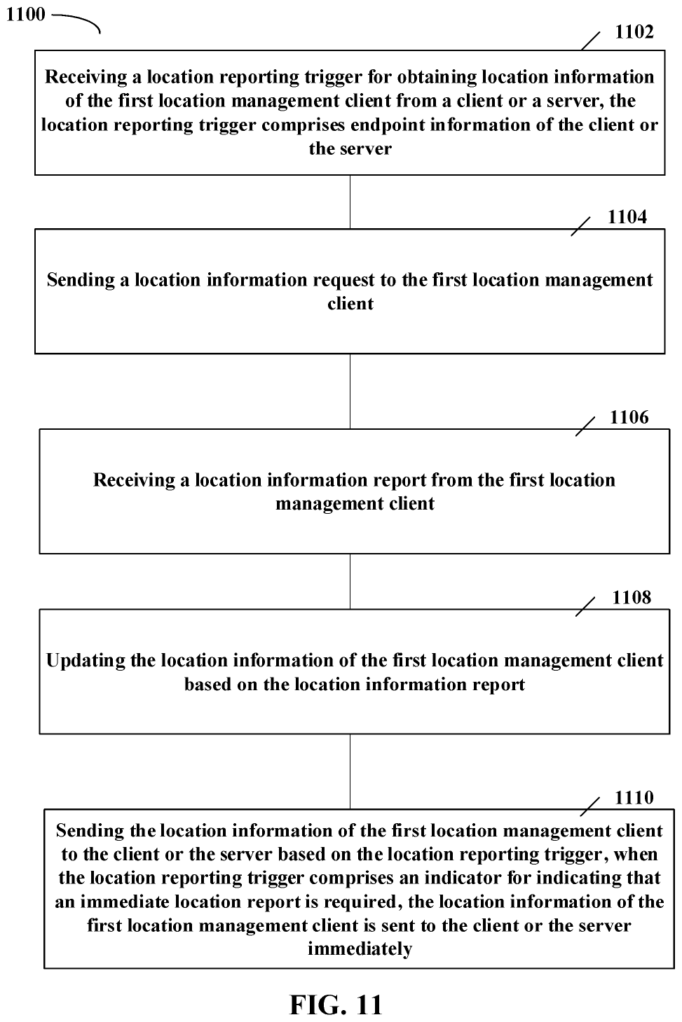

FIG. 11 shows a flowchart of a method 1100 according to another embodiment of the present disclosure, which may be performed by an apparatus implemented in or at or as a location management server or communicatively coupled to the location management server. As such, the apparatus may provide means or modules for accomplishing various parts of the method 1100 as well as means or modules for accomplishing other processes in conjunction with other components.

At block 1102, the location management server receives a location reporting trigger for obtaining location information of the first location management client from a client or a server. The location reporting trigger comprises endpoint information (such as URI (Uniform Resource Identifier) or {IP (Internet protocol) address+port number}) of the client or the server. For example, the location management client (authorized VAL user or VAL UE) or VAL server may send a location reporting trigger to the location management server to activate a location reporting procedure for obtaining the location information of a target location management client. In an embodiment, the location reporting trigger may be same as the location reporting trigger as described in 9.3.2.4 of 3GPP TS 23.434 V16.4.0.

In an embodiment, the client may be a second location management client and the server may be a vertical application layer (VAL) server.

At block 1104, the location management server sends a location information request to the first location management client. The location management server checks whether the location management client or VAL server is authorized to send the location reporting trigger. Depending on the information specified by the location reporting trigger, the location management server may initiate an on-demand location reporting procedure or an event-triggered location reporting procedure for the location of the target location management client.

In an embodiment, when the location reporting trigger comprises an indicator for indicating that an immediate location report is required, the location information of the first location management client is sent to the client or the server immediately.

After receiving the location information request, VAL user or VAL UE is notified and asked about the permission to share its location. VAL user can accept or deny the request. The location management client immediately responds to the location management server with a report containing location information identified by the location management server and available to the location management client.

At block 1106, the location management server receives a location information report from the first location management client.

At block 1108, the location management server updates the location information of the first location management client based on the location information report. Upon receiving the location information report, the location management server updates location of the reporting location management client. If the location management server does not have location information of the reporting location management client before, then just stores the reporting location information for that location management client.

At block 1110, the location management server sends the location information of the first location management client to the client or the server based on the location reporting trigger. For example, after receiving the location information from the target LMC, if immediate location reporting was requested, the LMS shall send the location information report to the requesting LMC or VAL server.

In an embodiment, a communication between a location management client and the location management server is implemented through a third Generation Partnership Project (3GPP) network system.

In an embodiment, the location management server may be a Service Enabler Architecture Layer for Verticals (SEAL) server and the location management client may be a vertical application layer (VAL) client as described in 3GPP TS 23.434 V16.4.0.

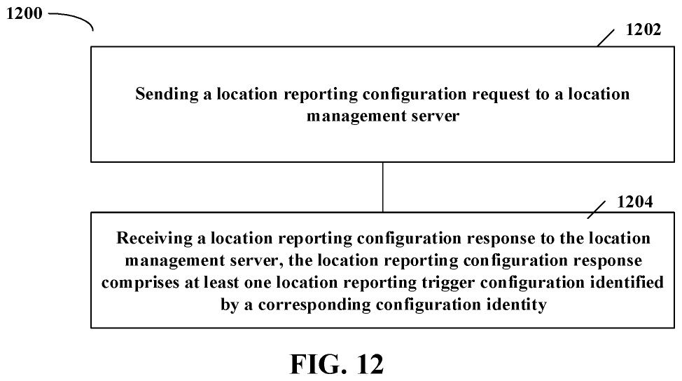

FIG. 12 shows a flowchart of a method 1200 according to another embodiment of the present disclosure, which may be performed by an apparatus implemented in or at or as a first location management client or communicatively coupled to the first location management client. As such, the apparatus may provide means or modules for accomplishing various parts of the method 1200 as well as means or modules for accomplishing other processes in conjunction with other components. For some parts which have been described in the above embodiments, detailed description thereof is omitted here for brevity.

At block 1202, the first location management client sends a location reporting configuration request to a location management server.

At block 1204, the first location management client receives a location reporting configuration response from the location management server. The location reporting configuration response comprises at least one location reporting trigger configuration identified by a corresponding configuration identity.

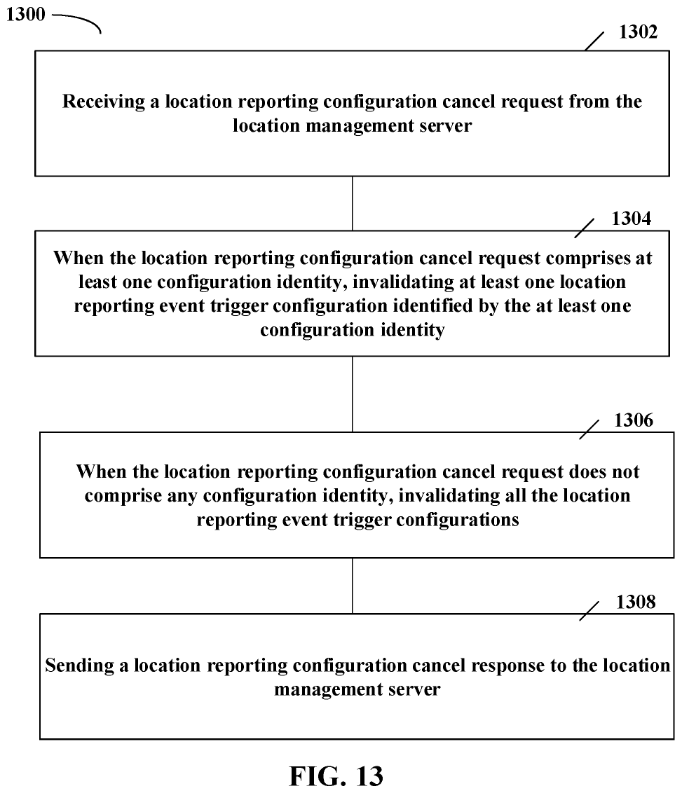

FIG. 13 shows a flowchart of a method 1300 according to another embodiment of the present disclosure, which may be performed by an apparatus implemented in or at or as a first location management client or communicatively coupled to the first location management client. As such, the apparatus may provide means or modules for accomplishing various parts of the method 1300 as well as means or modules for accomplishing other processes in conjunction with other components. For some parts which have been described in the above embodiments, detailed description thereof is omitted here for brevity.

At block 1302, the first location management client receives a location reporting configuration cancel request from the location management server.

At block 1304, when the location reporting configuration cancel request comprises at least one configuration identity, the first location management client invalidates at least one location reporting event trigger configuration identified by the at least one configuration identity.

At block 1306, when the location reporting configuration cancel request does not comprise any configuration identity, the first location management client invalidates all the location reporting event trigger configurations.

At block 1308, the first location management client sends a location reporting configuration cancel response to the location management server.

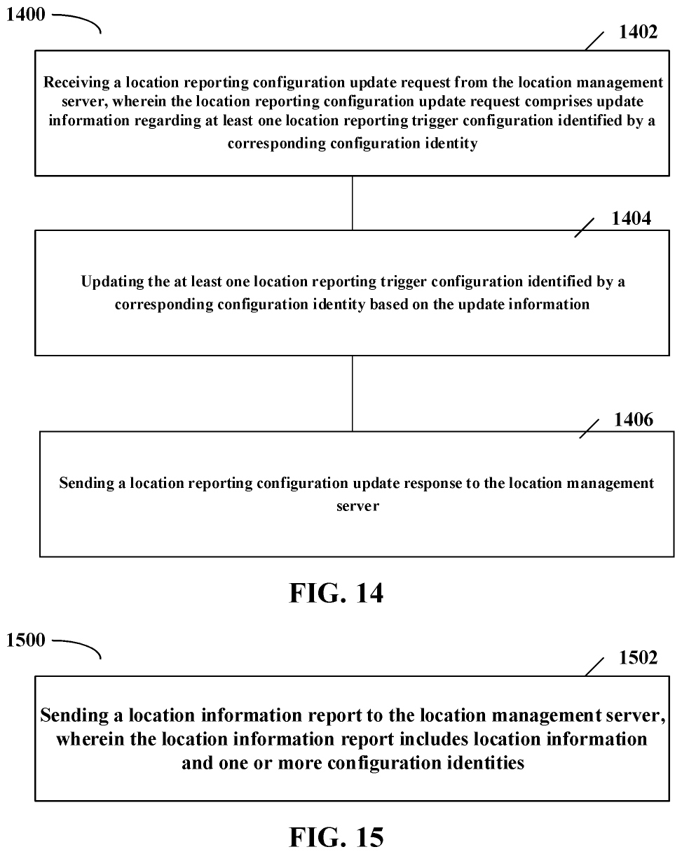

FIG. 14 shows a flowchart of a method 1400 according to another embodiment of the present disclosure, which may be performed by an apparatus implemented in or at or as a first location management client or communicatively coupled to the first location management client. As such, the apparatus may provide means or modules for accomplishing various parts of the method 1400 as well as means or modules for accomplishing other processes in conjunction with other components. For some parts which have been described in the above embodiments, detailed description thereof is omitted here for brevity.

At block 1402, the first location management client receives a location reporting configuration update request from the location management server. The location reporting configuration update request comprises update information regarding at least one location reporting trigger configuration identified by a corresponding configuration identity.

At block 1404, the first location management client updates the at least one location reporting trigger configuration identified by a corresponding configuration identity based on the update information.

At block 1406, the first location management client sends a location reporting configuration update response to the location management server.

FIG. 15 shows a flowchart of a method 1500 according to another embodiment of the present disclosure, which may be performed by an apparatus implemented in or at or as a first location management client or communicatively coupled to the first location management client. As such, the apparatus may provide means or modules for accomplishing various parts of the method 1500 as well as means or modules for accomplishing other processes in conjunction with other components. For some parts which have been described in the above embodiments, detailed description thereof is omitted here for brevity.

At block 1502, the first location management client sends a location information report to the location management server. The location information report includes location information and one or more configuration identities.

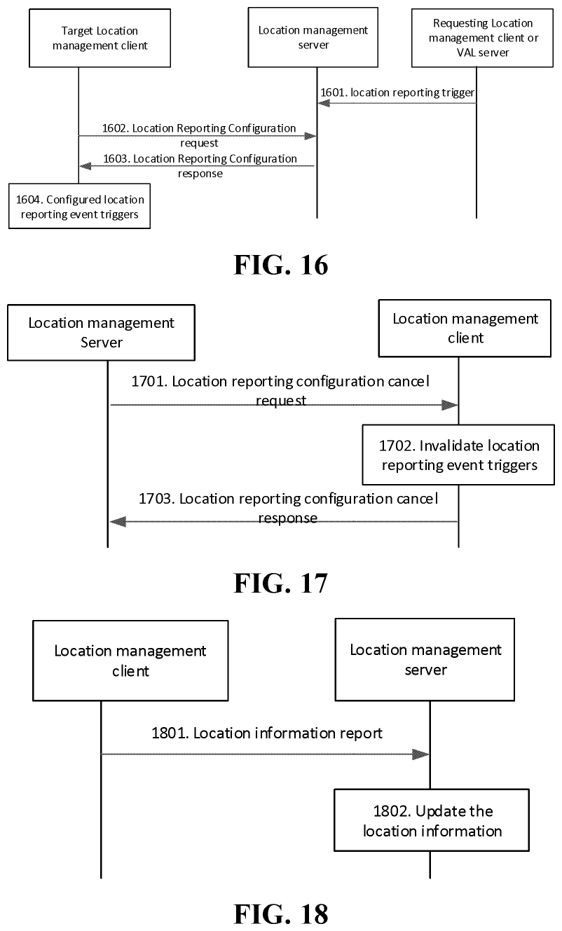

FIG. 16 shows a flowchart of event-triggered location reporting according to another embodiment of the present disclosure.

At step 1601, the requesting location management client or VAL server sends a location reporting trigger to the location management server. Different requesting LMC or VAL server may configure different location reporting criteria on the LMS.

At step 1602, the location management client sends a location reporting configuration request message to the location management server.

At step 1603, the location management server sends location reporting configuration response message to the location management client(s), containing at least one location reporting trigger configuration (or a subsequent update) identified by a corresponding configuration identity, e.g. minimum time between consecutive reports, SAI changes, or ECGI changes for reporting the location of the VAL UE. This message can be sent over a unicast bearer to a specific location management client or as a group message over an MBMS bearer to update the location reporting configuration for multiple location management clients at the same time.

At step 1604, the location management client stores or updates the location reporting event triggers configuration. When a location reporting event occurs, the configured location reporting event triggers.

FIG. 17 shows a flowchart of location reporting event triggers configuration cancel according to another embodiment of the present disclosure.

At step 1701, the location management server sends the location reporting configuration cancel request to the location management client to stop receiving the UE location information. This message can be sent via unicast or multicast. The location reporting configuration cancel request comprises at least one configuration identity for invalidating at least one location reporting event trigger configuration identified by the at least one configuration identity. When the location reporting configuration cancel request does not comprise any configuration identity, all the location reporting event trigger configurations are invalidated

At step 1702, the location management client invalidates the location reporting event triggers configuration identified by the at least one configuration identity.

At step 1703, the location management client sends the location reporting configuration cancel response to the location management server.

FIG. 18 shows a flowchart of location reporting procedure according to another embodiment of the present disclosure.

At step 1801, the location management client sends a location information report to the location management server, containing location information identified by one or more configuration identities and available to the location management client.

At step 1802, upon receiving the location information report, the location management server updates location of the reporting location management client. If the location management server does not have location information of the reporting location management client before, then just stores the reporting location information for that location management client.

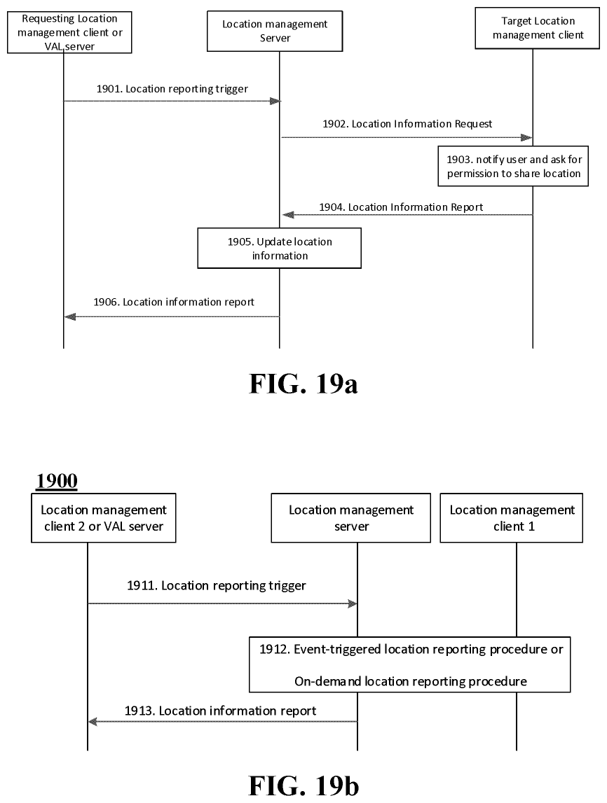

FIG. 19a shows a flowchart of on-demand location information reporting procedure according to another embodiment of the present disclosure.

At step 1901, the requesting location management client or VAL server sends location reporting trigger to a location management server. For example, the requesting LMC or VAL server shall include the endpoint information (URI or {IP address+port number}) of the VAL server or location management client to which the location information report has to be sent.

At step 1902, the location management server sends a location information request to the location management client.

At step 1903, VAL user or VAL UE is notified and asked about the permission to share its location. VAL user can accept or deny the request

At step 1904, the location management client immediately responds to the location management server with a report containing location information identified by the location management server and available to the location management client.

At step 1905, upon receiving the report, the location management server updates location of the reporting location management client. If the location management server does not have location information of the reporting location management client before, then just stores the reporting location information for that location management client.

At step 1906, the location management server sends the location information report to the requesting location management client or VAL server. For example, after receiving the location information from the target LMC, if immediate location reporting was requested, the LMS shall send the report to the requesting LMC or VAL server.

According to various embodiments, the proposed solution may allow multiple location reporting triggers configurations and add configuration ID to identify each location reporting triggers configuration.

The following content may be added into the 3GPP TS 23.434 V16.4.0.

***First Change****

9.3.2.1 Location Reporting Configuration Response

Table 9.3.2.1-1 describes the information flow from the location management server to the location management client for the location reporting configuration. This information flow may be sent individually addressed or group addressed on unicast or multicast.

TABLE 9.3.2.1-1
Location reporting configuration response

| Information element | Status | Description |
|---|---|---|
| Identity | M | Identity of the VAL user or VAL group to which the |
| | | location reporting configuration is targeted or |
| | | identity of the VAL UE. |
| location reporting triggers | O (NOTE) | The location reporting triggers configuration list. |
| configuration(s) | | |
| >Configuration ID | O (NOTE) | Identifies a specific configuration, shall be provided |
| | | when more than one configuration is supplied. |
| >Requested location information | O (NOTE) | Identifies what location information is requested |
| >Triggering criteria | O (NOTE) | Identifies when the location management client will |
| | | send the location report |
| >Minimum time between | O (NOTE) | Defaults to 0 if absent otherwise indicates the time |
| consecutive reports | | interval between consecutive reports |

(NOTE):
If none of the information element is present, this represents a cancellation for location reporting.

***Next Change****

9.3.2.2 Location Information Report

Table 9.3.2.2-1 describes the information flow from the location management client to the location management server for the location information reporting or from the location management server to the requesting location management client or VAL server to report location information.

TABLE 9.3.2.2-1
Location information report

| Information element | Status | Description |
|---|---|---|
| Set of identities | M | Set of identities of the reporting |
| | | VAL users or VAL UEs |
| Triggering event | M | Identity of the event that triggered |
| | | the sending of the report |
| Location Information | M | Location information |

***Next Change****

9.3.2.4 Location Reporting Trigger

Table 9.3.2.4-1 describes the information flow from the location management client to the location management server for triggering a location reporting procedure.

TABLE 9.3.2.4-1
Location reporting trigger

| Information element | Status | Description |
|---|---|---|
| Identity | M (NOTE 1) | Identity of the requesting authorized VAL user or |
| | | VAL UE |
| Identity | M (NOTE 1) | Identity of the requested VAL user or VAL UE |
| Immediate Report Indicator | O (NOTE 2) | Indicates whether an immediate location report is |
| | | required |
| Requested location information | O (NOTE 2) | Identifies what location information is requested |
| Triggering criteria | O (NOTE 2) | Identifies when the client will send the location |
| | | report |
| Minimum time between | O (NOTE 2) | Defaults to 0 if absent otherwise indicates the |
| consecutive reports | | interval time between consecutive reports |
| Endpoint information | O | Information of the endpoint of the VAL server or |
| | | location management client to which the location |
| | | report has to be sent. It is provided if Immediate |
| | | Report Indicator is set to required. |

(NOTE 1):
The identity of the requesting VAL user/UE and the requested VAL user/UE should belong to the same VAL service.
(NOTE 2):
At least one of these rows shall be present.

***Next Change****

9.3.3.2 Fetching Location Reporting Configuration

Pre-Condition:
If multicast delivery mode is used, the MBMS bearer being used is activated by the location management server.
The location management client is aware that the location reporting configuration is available at the location management server.

1. The location management client sends location reporting configuration request message to the location management server.

2. The location management server sends location reporting configuration message to the location management client(s) containing the initial location reporting event triggers configuration(s) (or a subsequent update), e.g. minimum time between consecutive reports, SAI changes, or ECGI changes for reporting the location of the VAL UE. This message can be sent over a unicast bearer to a specific location management client or as a group message over an MBMS bearer to update the location reporting configuration(s) for multiple location management clients at the same time.

NOTE 1: The location reporting configuration information can be made part of the user profile, in which case the sending of the message is not necessary.

NOTE 2: Different location management clients or the same location management client may be given different location reporting criteria.

3. The location management client stores or updates the location reporting event triggers configuration.

***Next Change****

9.3.3.3 Location Reporting

1. The location management client sends a location information report to the location management server, containing location information identified by the location management server and available to the location management client and configuration ID if it was received during fetching location report configuration procedure.

2. Upon receiving the report, the location management server updates location of the reporting location management client. If the location management server does not have location information of the reporting location management client before, then just stores the reporting location information for that location management client.

***Next Change****

9.3.5 Client-Triggered or VAL Server-Triggered Location Reporting Procedure

FIG. 9.3.5-1 of 3GPP TS 23.434 V16.4.0 may be amended as FIG. 19b. FIG. 19b illustrates the high level procedure 1900 of client-triggered or VAL server-triggered location reporting.

1911. Location management client 2 (authorized VAL user or VAL UE) or VAL server sends a location reporting trigger to the location management server to activate a location reporting procedure for obtaining the location information of location management client 1.

1912. Location management server checks whether location management client 2 or VAL server is authorized to send a location reporting trigger. Depending on the information specified by the location reporting trigger, location management server initiates an on-demand location reporting procedure or an event-triggered location reporting procedure for the location of location management client 1.

1913. Once the location information of the location management client 1 is available in the location management server by the on-demand location reporting procedure, a location information report is sent to the location management client 2 or VAL server.

***Next Change****

9.3.6 Location Reporting Event Triggers Configuration Cancel

Pre-Conditions:

1. The location management server has subscribed the location management client location with the location reporting event triggers.

2. If multicast delivery mode is used, the MBMS bearer being used is activated by the location management server.

1. The location management server sends the location reporting configuration cancel request to the location management client to stop receiving the UE location information. This message can be sent via unicast or multicast.

2. The location management client invalidates the location reporting event triggers configuration for the indicated configuration ID and no longer reports its location to the location management server. If no configuration ID is provided, the location management client invalidates all location reporting event triggers configuration(s) and no longer reports its location to the location management server.

3. The location management client sends the location reporting configuration cancel response to the location management server.

*** End of Changes****

The various blocks shown in FIGS. 7-18, 19a and 19b may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

Embodiments herein afford many advantages, of which a non-exhaustive list of examples follows. In some embodiments herein, the proposed solution may fulfill immediate reporting requirement for requesting VAL UE/user in the existing location management procedure for SEAL on-network model. In some embodiments herein, the proposed solution may support multiple location reporting trigger configurations in the existing location management procedure for SEAL on-network model. The embodiments herein are not limited to the features and advantages mentioned above. A person skilled in the art will recognize additional features and advantages upon reading the following detailed description.

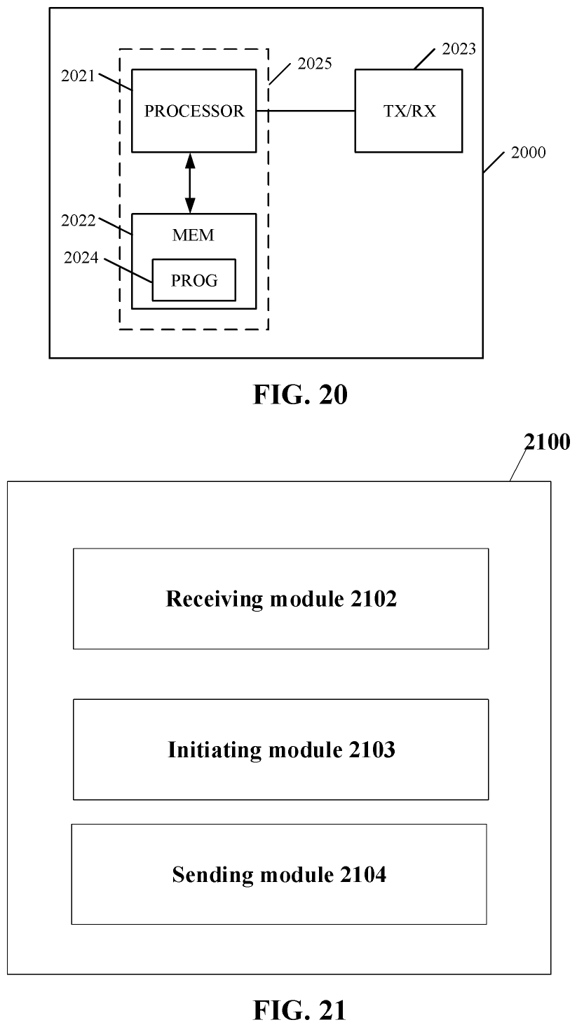

FIG. 20 is a block diagram showing an apparatus suitable for practicing some embodiments of the disclosure. For example, any one of the location management server or the client or the server described above may be implemented as or through the apparatus 2000.

The apparatus 2000 comprises at least one processor 2021, such as a digital processor (DP), and at least one memory (MEM) 2022 coupled to the processor 2021. The apparatus 2020 may further comprise a transmitter TX and receiver RX 2023 coupled to the processor 2021. The MEM 2022 stores a program (PROG) 2024. The PROG 2024 may include instructions that, when executed on the associated processor 2021, enable the apparatus 2020 to operate in accordance with the embodiments of the present disclosure. A combination of the at least one processor 2021 and the at least one MEM 2022 may form processing means 2025 adapted to implement various embodiments of the present disclosure.

Various embodiments of the present disclosure may be implemented by computer program executable by one or more of the processor 2021, software, firmware, hardware or in a combination thereof.

The MEM 2022 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 2021 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the location management server, the memory 2022 contains instructions executable by the processor 2021, whereby the location management server operates according to any step of any of the methods related to the location management server as described above.

In an embodiment where the apparatus is implemented as or at the client or the server, the memory 2022 contains instructions executable by the processor 2021, whereby the client or the server operates according to any step of the methods related to the client or the server as described above.

FIG. 21 is a block diagram showing a location management server according to an embodiment of the disclosure. As shown, the location management server 2100 comprises a receiving module 2102, an initiating module 2103 and a sending module 2104. The receiving module 2102 may be configured to receive a location reporting trigger for activating a location reporting procedure for obtaining location information of a first location management client from a client or a server. The location reporting trigger comprises endpoint information of the client or the server. The initiating module 2103 may be configured to initiate a location reporting procedure for the location information of the first location management client. The sending module 2104 may be configured to, when location information of the first location management client is available in the location management server, send a location information report comprising the location information of the first location management client to the client or the server based on the endpoint information of the client or the server.

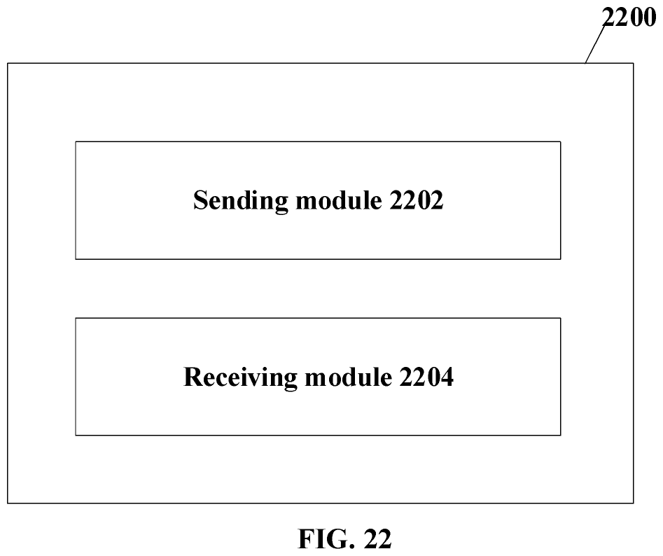

FIG. 22 is a block diagram showing a client or a server according to an embodiment of the disclosure. As shown, the client or server 2200 comprises a sending module 2202 and a receiving module 2204. The sending module 2202 may be configured to send a location reporting trigger for activating a location reporting procedure for obtaining location information of a first location management client to a location management server. The location reporting trigger comprises endpoint information of the client or the server. The receiving module 2204 may be configured to receive a location information report comprising the location information of the first location management client from the location management server.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the location management server or the client or the server may not need a fixed processor or memory, any computing resource and storage resource may be arranged from the location management server or the client or the server in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method at a location management server, comprising:
receiving a location reporting trigger for activating a location reporting procedure for obtaining location information of a first location management client from a client or a server, wherein the location reporting trigger comprises endpoint information of the client or the server;
initiating a location reporting procedure for the location information of the first location management client; and
when location information of the first location management client is available in the location management server, sending a location information report comprising the location information of the first location management client to the client or the server based on the endpoint information of the client or the server.

2. The method according to claim 1, further comprising:
receiving a location reporting configuration request from the first location management client; and
sending a location reporting configuration response to the first location management client,
wherein the location reporting configuration response comprises at least one location reporting trigger configuration identified by a corresponding configuration identity.

3. The method according to claim 2, wherein each of the at least one location reporting trigger configuration comprises at least one of:
requested location information;
triggering criteria; and
a minimum time between consecutive reports.

4. The method according to claim 2, wherein the location reporting configuration response further comprises an identity of a vertical application layer (VAL) user or an identity of a VAL group to which the location reporting configuration is targeted or an identity of the VAL user equipment.

5. The method according to claim 1, further comprising:
sending a location reporting configuration cancel request to the first location management client; and
receiving a location reporting configuration cancel response from the first location management client,
wherein the location reporting configuration cancel request comprises at least one configuration identity for invalidating at least one location reporting event trigger configuration identified by the at least one configuration identity, or wherein when the location reporting configuration cancel request does not comprise any configuration identity, all the location reporting event trigger configurations are invalidated.

6. The method according to claim 1, further comprising:
sending a location reporting configuration update request to the first location management client; and
receiving a location reporting configuration update response from the first location management client,
wherein the location reporting configuration update request comprises update information regarding at least one location reporting trigger configuration identified by a corresponding configuration identity.

7. The method according to claim 1, further comprising:
receiving a location information report from the first location management client, wherein the location information report includes location information and one or more configuration identities; and
updating the location information related to the one or more configuration identities based on the received location information.

8. The method according to claim 1, wherein the location reporting procedure comprises:
sending a location information request to the first location management client;
receiving a location information report from the first location management client; and
updating the location information of the first location management client based on the location information report.

9. The method according to claim 1, when the location reporting trigger comprises an indicator for indicating that an immediate location report is required, the location information of the first location management client is sent to the client or the server immediately.

10. The method according to claim 1, wherein the client is a second location management client and the server is a vertical application layer (VAL) server; and/or
wherein a communication between a location management client and the location management server is implemented through a third Generation Partnership Project network system.

11. (canceled)

12. The method according to claim 1, wherein the location management server is a Service Enabler Architecture Layer for Verticals (SEAL) server and the location management client is a vertical application layer (VAL) client.

13. A method at a client or a server, comprising:
sending a location reporting trigger for activating a location reporting procedure for obtaining location information of a first location management client to a location management server, wherein the location reporting trigger comprises endpoint information of the client or the server; and
receiving a location information report comprising the location information of the first location management client from the location management server.

14. The method according to claim 13, when the client is a location management client, the method further comprises:
sending a location reporting configuration request to the location management server; and
receiving a location reporting configuration response from the location management server,
wherein the location reporting configuration response comprises at least one location reporting trigger configuration identified by a corresponding configuration identity.

15. The method according to claim 14, wherein each of the at least one location reporting trigger configuration comprises at least one of:
requested location information;
triggering criteria; and
a minimum time between consecutive reports.

16. The method according to claim 14, wherein the location reporting configuration response further comprises an identity of a vertical application layer (VAL) user or an identity of a VAL group to which the location reporting configuration is targeted or an identity of the VAL user equipment.

17. The method according to claim 14, further comprising:
receiving a location reporting configuration cancel request from the location management server;
when the location reporting configuration cancel request comprises at least one configuration identity, invalidating at least one location reporting event trigger configuration identified by the at least one configuration identity;
when the location reporting configuration cancel request does not comprise any configuration identity, invalidating all the location reporting event trigger configurations; and
sending a location reporting configuration cancel response to the location management server.

18. The method according to claim 14, further comprising:
receiving a location reporting configuration update request from the location management server, wherein the location reporting configuration update request comprises update information regarding at least one location reporting trigger configuration identified by a corresponding configuration identity;
updating the at least one location reporting trigger configuration identified by a corresponding configuration identity based on the update information; and
sending a location reporting configuration update response to the location management server.

19. The method according to claim 14, further comprising:
sending a location information report to the location management server, wherein the location information report includes location information and one or more configuration identities.

20-22. (canceled)

23. A location management server, comprising:
a processor; and
a memory coupled to the processor, said memory containing instructions executable by said processor, whereby said location management server is operative to:
receive a location reporting trigger for activating a location reporting procedure for obtaining location information of a first location management client from a client or a server, wherein the location reporting trigger comprises endpoint information of the client or the server;
initiate a location reporting procedure for the location information of the first location management client; and
when location information of the first location management client is available in the location management server, send a location information report comprising the location information of the first location management client to the client or the server based on the endpoint information of the client or the server.

24. (canceled)

25. A client or a server, comprising:
a processor; and
a memory coupled to the processor, said memory containing instructions executable by said processor, whereby said client or server is operative to:
send a location reporting trigger for activating a location reporting procedure for obtaining location information of a first location management client to a location management server, wherein the location reporting trigger comprises endpoint information of the client or the server; and
receive a location information report comprising the location information of the first location management client from the location management server.

26-28. (canceled)
